(19) United States
(12) Patent Application Publication
(10) Pub. No.: US 2026/0019832 A1
(43) Pub. Date: Jan. 15, 2026

(54) PERFORMANCE MODEL CONSTRUCTION APPARATUS, PERFORMANCE MODEL CONSTRUCTION METHOD AND PROGRAM

(71) Applicant: NTT, Inc., Tokyo (JP)

(72) Inventors: Hideaki KINSHO, Tokyo (JP); Kei TAKESHITA, Tokyo (JP)

(21) Appl. No.: 18/992,354

(22) PCT Filed: Jul. 15, 2022
(86) PCT No.: PCT/JP2022/027846

§ 371 Date: Jan. 8, 2025

(51) Int. Cl. H04W 24/02; G06F 18/20; H04W 24/08

(52) U.S. Cl. CPC H04W 24/02; G06F 18/29; H04W 24/08

(57) ABSTRACT

A performance model construction apparatus according to an aspect of the present disclosure is a performance model construction apparatus that constructs a performance model of each base station constituting a cellular network, the apparatus including an input unit configured to input an accommodated user number observation value representing an observation value of the number of accommodated users of each base station and a performance observation value representing an observation value of predetermined performance related to the base station when the accommodated user number observation value is observed, and a construction unit configured to construct a performance model representing a relationship between the number of accommodated users and the performance using the accommodated user number observation value, the performance observation value, and the number of observations of the accommodated user number observation value and the performance observation value.

### TECHNICAL FIELD

The present disclosure relates to a performance model construction apparatus, a performance model construction method, and a program.

### BACKGROUND ART

Cellular networks generally include many base stations as elements, and each base station covers a surrounding area. As a result, in the cellular networks, users can perform communications via the base stations around the users.

A range covered by each base station is determined depending on setting values of various parameters and surrounding environmental factors, and one of representative parameters is a tilt angle. Many tilt angle optimization methods for improving performance (for example, throughput) of a base station in a cellular network have been proposed so far. For example, a method of calculating a tilt angle for equalizing the number of accommodated users in each base station has been proposed.

On the other hand, since the performance of the base station is determined based on various factors, the performance of each base station is not necessarily equivalent even if the same number of accommodated users is served. Therefore, a method of constructing a performance model for each base station by utilizing observation data of each base station has been proposed (Non Patent Literature 1).

### CITATION LIST

### Non Patent Literature

Non Patent Literature 1: Deniz Ustebay and Jie Chuai. “Hierarchical Bayesian Modelling for Wireless Cellular Networks,” In Proceedings of the 2019 Workshop on Network Meets AI & ML (NetAI'19), p76-82, August 2019.

### SUMMARY OF INVENTION

### Technical Problem

However, in Non Patent Literature 1, since modeling is performed by general hierarchical Bayesian modeling, parameters that adjust the balance between the trend of the overall base stations and the trend of each individual base station are uniformly estimated for all base stations. For this reason, for example, it is not possible to perform adjustments, such as constructing a model that focuses on the overall trend for base stations with a small number of observations, and that focuses on individual characteristics for base stations with a large number of observations.

The present disclosure has been made in view of the above points, and provides a technique capable of constructing a performance model in consideration of the number of observations for each base station.

### Solution to Problem

A performance model construction apparatus according to an aspect of the present disclosure is a performance model construction apparatus that constructs a performance model of each base station constituting a cellular network, the apparatus including an input unit configured to input an accommodated user number observation value representing an observation value of the number of accommodated users of each base station and a performance observation value representing an observation value of predetermined performance related to the base station when the accommodated user number observation value is observed, and a construction unit configured to construct a performance model representing a relationship between the number of accommodated users and the performance using the accommodated user number observation value, the performance observation value, and the number of observations of the accommodated user number observation value and the performance observation value.

### Advantageous Effects of Invention

A technique capable of constructing a performance model in consideration of the number of observations for each base station is provided.

### BRIEF DESCRIPTION OF DRAWINGS

FIG. 1 is a diagram illustrating an example of a hardware configuration of a performance model construction device according to the present embodiment.

FIG. 2 is a diagram illustrating an example of a functional configuration of the performance model construction device according to the present embodiment.

FIG. 3 is a diagram illustrating an example of observation data.

FIG. 4 is a flowchart illustrating an example of overall processing of performance model construction.

FIG. 5 is a flowchart illustrating an example of detailed processing of the performance model construction.

FIG. 6 is a diagram for illustrating a calculation example of a parameter a.

### DESCRIPTION OF EMBODIMENTS

Hereinafter, embodiments of the present invention will be described. In the following embodiment, a performance model construction device 10 that constructs a performance model in consideration of the number of observations for each base station when constructing a performance model of each base station will be described. In the following, as an example, a throughput is assumed as the performance of the base station. However, the performance of the base station is not limited to the throughput, and the present embodiment can be similarly applied to various performance characteristics other than the throughput.

Here, it is assumed that observation data D including observation information of each base station is given to the performance model construction device 10. The observation information is any statistic that has been already observed in a real network. Hereinafter, as an example, it is assumed that the observation information of each base station includes the number of accommodated users and the throughput of the base station at each time. Further, hereinafter, a total number of base stations is denoted by N, and an i-th (where i=1, . . . , N) base station is denoted by BSᵢ.

### Hardware Configuration Example of Performance Model Construction Device 10

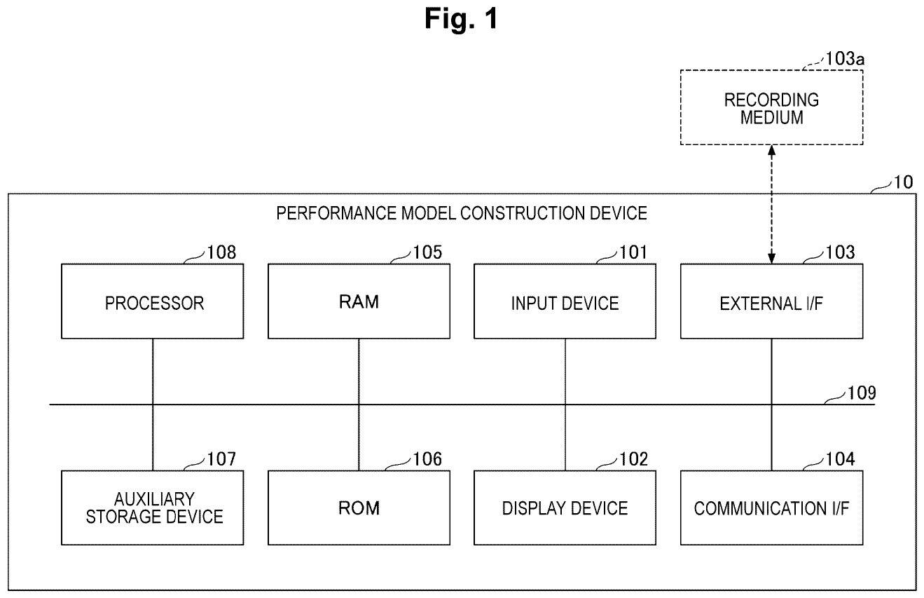

FIG. 1 illustrates a hardware configuration example of the performance model construction device 10 according to the present embodiment. As illustrated in FIG. 1, the performance model construction device 10 according to the present embodiment includes an input device 101, a display device 102, an external I/F 103, a communication I/F 104, a random access memory (RAM) 105, a read only memory (ROM) 106, an auxiliary storage device 107, and a processor 108. These hardware components are communicatively connected to one another via a bus 109.

The input device 101 includes, for example, a keyboard, a mouse, a touch panel, a physical button, and/or the like. The display device 102 is, for example, a display, a display panel, or the like. The performance model construction device 10 may not include, for example, at least one of the input device 101 or the display device 102.

The external I/F 103 is an interface with an external device such as a recording medium 103a. The performance model construction device 10 can perform reading or writing with respect to the recording medium 103a via the external I/F 103. Examples of the recording medium 103a include a flexible disk, a compact disc (CD), a digital versatile disk (DVD), a secure digital memory card (SD memory card), a universal serial bus (USB) memory card, and the like.

The communication I/F 104 is an interface for the performance model construction device 10 to communicate with other apparatuses, devices, and the like. The RAM 105 is a volatile semiconductor memory (storage device) that temporarily holds programs and data. The ROM 106 is a non-volatile semiconductor memory (storage device) capable of holding programs and data even when the power is turned off. The auxiliary storage device 107 is, for example, a storage device (storage device) such as a hard disk drive (HDD), a solid state drive (SSD), or a flash memory. The processor 108 is, for example, an arithmetic device such as a central processing unit (CPU) or a graphics processing unit (GPU).

The performance model construction device 10 according to the present embodiment has the hardware configuration illustrated in FIG. 1 and can thus implement various processes that will be described below. The hardware configuration illustrated in FIG. 1 is an example, and a hardware configuration of the performance model construction device 10 is not limited to the above example. For example, the performance model construction device 10 may include a plurality of auxiliary storage devices 107 and/or a plurality of processors 108, may not include a part of the illustrated hardware, or may include various hardware components other than the illustrated hardware.

### Functional Configuration Example of Performance Model Construction Device 10

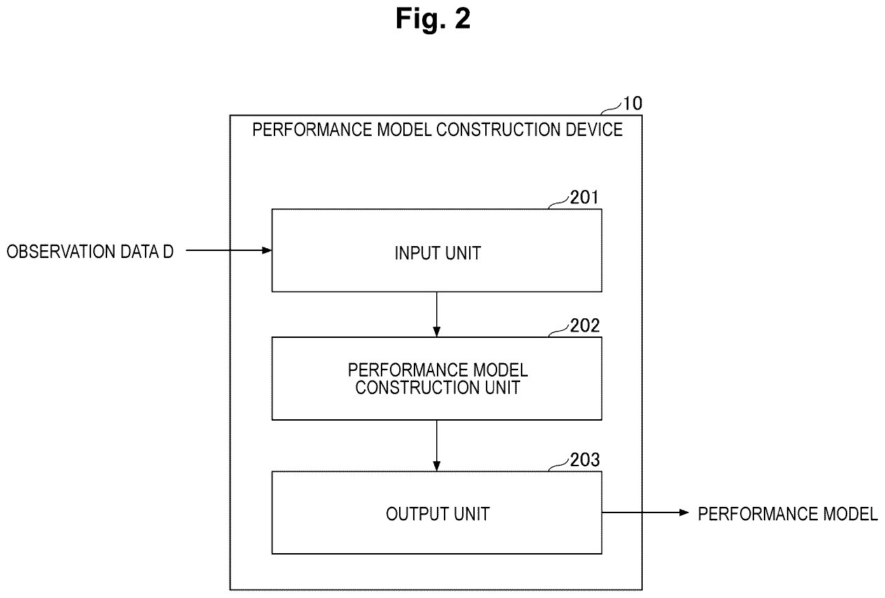

FIG. 2 illustrates a functional configuration example of the performance model construction device 10 according to the present embodiment. As illustrated in FIG. 2, the performance model construction device 10 according to the present embodiment includes an input unit 201, a performance model construction unit 202, and an output unit 203. Each of these units is implemented, for example, by processing executed by the processor 108 using one or more programs that are installed in the performance model construction device 10.

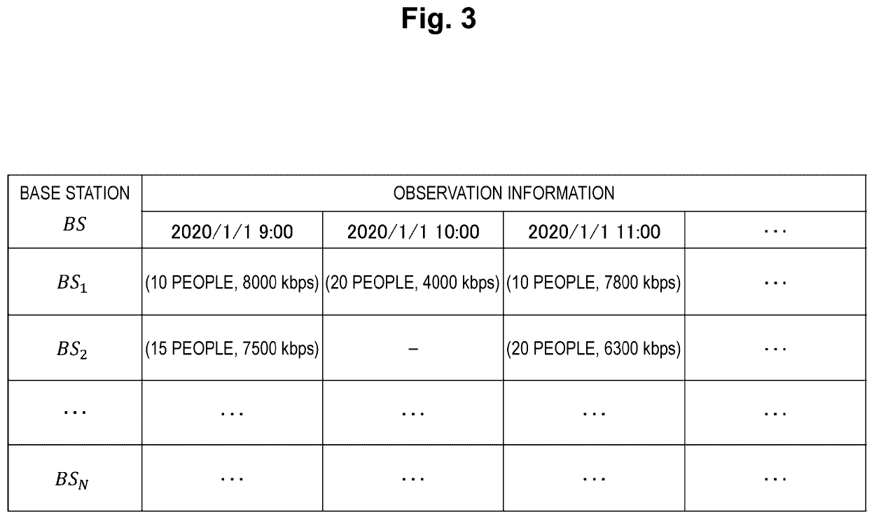

The input unit 201 inputs given observation data D. Here, an example of the observation data D is illustrated in FIG. 3. As illustrated in FIG. 3, the observation data D includes, for each base station BSᵢ, observation information (the number of accommodated users and throughput) of the base station BSᵢ at each time. Note that the time may include not only an hour and minutes but also a year, month, and day, and may further include seconds (in the example illustrated in FIG. 3, the time is represented by a year, month, day, hour, and minute).

The observation data D illustrated in FIG. 3 includes the observation information of the base station BS₁ from the time “9:00, Jan. 1, 2020” to “11:00, Jan. 1, 2020.” On the other hand, the observation data D illustrated in FIG. 3 includes the observation information of the base station BS₂ at the time “9:00, Jan. 1, 2020” and “11:00, Jan. 1, 2020,” but does not include the observation information of the base station BS₂ at the time “10:00, Jan. 1, 2020.” This means that the number of accommodated users and the throughput of the base station BS₂ at the time “10:00, Jan. 1, 2020” are not observed. As described above, in a case where the number of accommodated users and the throughput of a certain base station are not observed at a certain time, the observation information of the base station at the time is not included in the observation data D.

In general, if observation information of the base station BSᵢ at the time t is given as dₜ⁽ⁱ⁾, the observation data D can be expressed as D={dₜ⁽ⁱ⁾|i=1, . . . , N, t∈Tᵢ}. In addition, if the number of accommodated users of the base station BSᵢ at the time t is given as xₜ⁽ⁱ⁾ and the throughput is given as yₜ⁽ⁱ⁾, observation information dₜ⁽ⁱ⁾ can be expressed as dₜ⁽ⁱ⁾=(xₜ⁽ⁱ⁾, yₜ⁽ⁱ⁾). Here, Tᵢ is a set of times when the number of accommodated users in the base station BSᵢ and the throughput are observed. At this time, the number of elements of Tᵢ, that is, |Tᵢ| is the number of observations of the base station BSᵢ.

Using the observation information included in the observation data D that is input by the input unit 201, the performance model construction unit 202 constructs, for each base station BSᵢ, a model (performance model) representing the relationship between the number of accommodated users in the base station BSᵢ and the throughput. At this time, the performance model construction unit 202 constructs a performance model in consideration of the number of observations of the base station BSᵢ. Details of a construction method of the performance model will be described later.

The output unit 203 outputs the performance model constructed by the performance model construction unit 202 to a predetermined output destination set in advance. Note that the output unit 203 may output the performance model to, for example, a server device or the like that is connected via a communication network such as the Internet, may output the performance model to the display device 102 such as a display, or may output the performance model to a storage device such as the auxiliary storage device 107.

### <Overall Processing of Performance Model Construction>

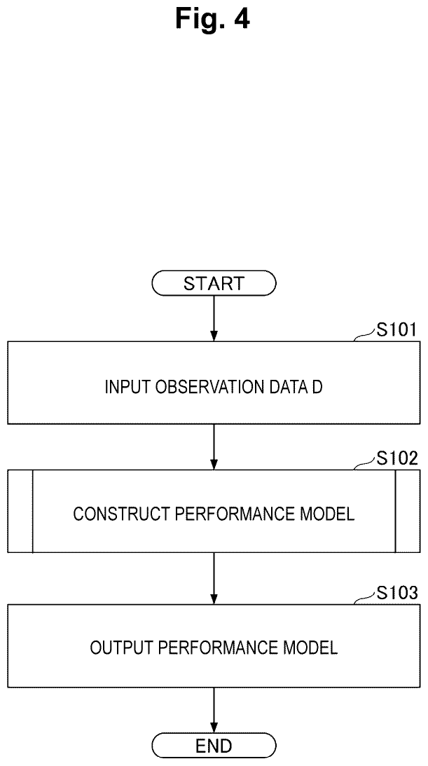

The overall processing of the performance model construction will be described below with reference to FIG. 4.

First, the input unit 201 inputs given observation data D (step S101).

Next, the performance model construction unit 202 constructs, for each base station BSᵢ, a performance model representing the relationship between the number of accommodated users by the base station BSᵢ and the throughput, with use of observation information included in the observation data D input in step S101 described above (step S102). Note that details of the processing of this step will be described later.

Then, the output unit 203 outputs the performance model (performance model for each base station BSᵢ) constructed in step S102 described above, to a predetermined output destination that is set in advance (step S103).

### <<Detailed Processing of Performance Model Construction>>

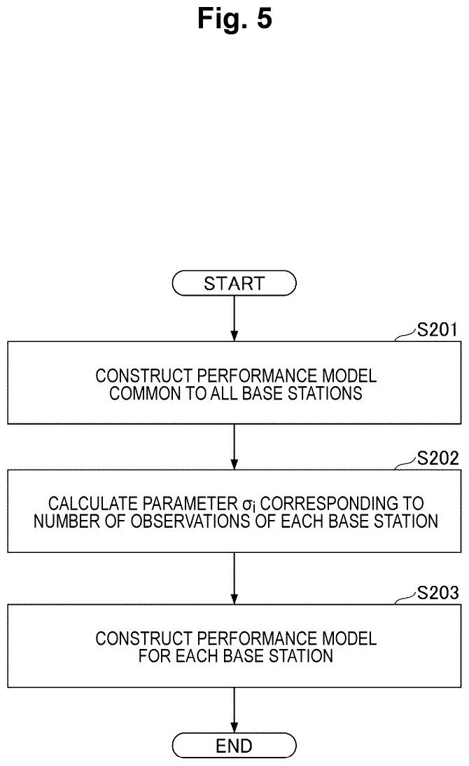

Hereinafter, the detailed processing of constructing the performance model in step S102 will be described with reference to FIG. 5.

First, the performance model construction unit 202 constructs the performance model that is common to all base stations using the observation information included in the observation data D (step S201). Hereinafter, it is assumed that the performance model is expressed in a form of y=exp(βx+γ). Here, y is the throughput, x is the number of accommodated users, and β and γ are parameters.

The performance model construction unit 202 may estimate the parameters β and γ of the performance model common to all the base stations, based on Bayesian modeling, for example. In a case where the parameters β and γ are estimated based on the Bayesian modeling, first, the performance model construction unit 202 estimates, for example, the following model parameters σ, β, and γ.

$$y ∼ Norm ( exp ( β x + γ ) , σ )$$

Here, σ, β, and γ are as follows.

σ˜HalfNorm(10⁴)

β˜Norm(0,10⁴)

γ˜Norm(0,10⁴)

In this model, it is assumed that the throughput y follows a Gaussian distribution (normal distribution) with an average exp (βx+γ) and a standard deviation σ, a prior distribution for the parameter σ is given as a semi-normal distribution as a noninformative prior distribution, and also, a prior distribution for the parameters β and γ is given as a normal distribution as the noninformative prior distribution.

At this time, the performance model construction unit 202 learns the posterior distribution for the parameters σ, β, and γ to maximize the probability of occurrence of the observation information, by using a Markov Chain Monte Carlo (MCMC) method with respect to the above model.

Then, the performance model construction unit 202 may set the performance model common to all the base stations to y=exp(μ_{β}x+μ_{γ}) by using, for example, an average value μ_{β} of β after learning and an average value μ_{γ} of γ after learning. Hereinafter, the performance model y=exp(μ_{β}x+μ_{γ}) common to all base stations is described as being constructed.

Note that the estimation method for the parameters β and γ is not limited to the Bayesian modeling, and for example, the parameters β and γ may be estimated by a least squares method. In a case where the parameters β and γ are estimated by the least squares method, the performance model construction unit 202 may obtain the parameters β and γ that minimize the sum of squares of the difference between yₜ⁽ⁱ⁾ and exp(βxₜ⁽ⁱ⁾+γ) for i=1, . . . , N and t∈Tᵢ.

Next, the performance model construction unit 202 calculates a parameter σᵢ corresponding to the number of observations of each base station BSᵢ (step S202). The parameter σᵢ is a parameter representing the magnitude of variation from the parameter μ_{β} (that is, one of parameters indicating the trend of all the base stations) estimated in step S201 above for the base station BSᵢ.

For example, the performance model construction unit 202 may calculate the parameter σᵢ for the base station BSᵢ by the following equation based on a sigmoid function.

$${σ}_{i} = \frac{b}{1 + {e}^{- a ( {n}_{i} - c )}} \qquad [ Math . 1 ]$$

Here, nᵢ is the number of observations of the base station BSᵢ, that is, nᵢ=|Tᵢ|. In addition, a, b, and c are parameters. In particular, a is a parameter for determining smoothness of the function shown in Equation 1 above, b is a parameter for determining an upper limit value of the function shown in Equation 1 above, and c is a parameter for determining a center of the function shown in Equation 1 above.

For example, the parameters a, b, and c may be determined based on observation information, or may be determined by a hyperparameter optimization method such as grid search or Bayesian optimization.

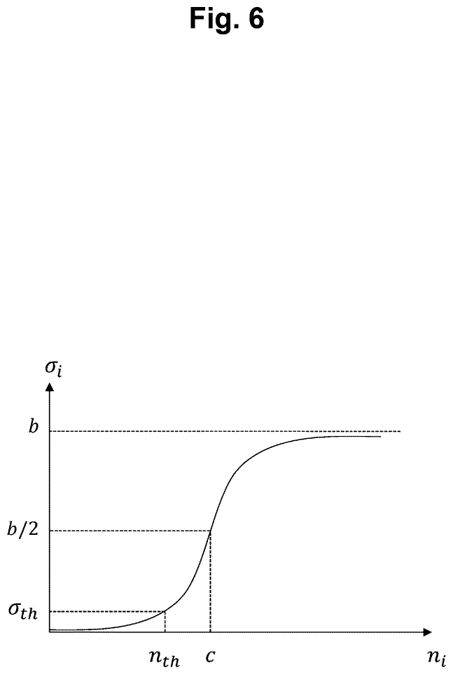

As an example, FIG. 6 illustrates a calculation example of the parameter σᵢ for the base station BSᵢ. In the example illustrated in FIG. 6, when the vertical axis expresses σᵢ and the horizontal axis expresses nᵢ, the parameter a is determined to pass through (nᵢ, σᵢ)=(nₜₕ, σₜₕ). That is, the parameter a is defined as follows.

$$a = - \frac{1}{{n}_{th} - c} log \frac{b - {σ}_{th}}{{σ}_{th}} \qquad [ Math . 2 ]$$

Here, as a value of nₜₕ, for example, it is conceivable to calculate a maximum value of the number of observations for which the performance model cannot be modeled well only using observation information of the base station alone by data analysis or the like in advance, and to then set the maximum value. Furthermore, it is conceivable that the value of σₜₕ is set to |μ_{β}/3| using, for example, the parameter μ_{β} for the performance model common to all the base stations. This means that, in sampling by the MCMC method, the sampling value exists in the range of (2μ_{β}, 0) with a probability of 99.7%. As a result, in a case where the number of observations of a certain base station BSᵢ is small, a parameter βᵢ to be described later is prevented from becoming a positive number, and a situation in which the performance model cannot be modeled well can be avoided.

In addition, the parameter b may be, for example, | |μ_{β}|−max(|βᵢ′|)| using a parameter βᵢ′ when the performance model is modeled only with the observation information of the base station alone.

Finally, the performance model construction unit 202 constructs a performance model for each base station BSᵢ using the observation information included in the observation data D, the parameters us and My obtained in step S201 described above, and the parameter σᵢ (i=1, . . . , N) obtained in step S202 described above (step S203).

The performance model construction unit 202 constructs a performance model of each base station BSᵢ by hierarchical Bayesian modeling. Specifically, assuming that the throughput of the base station BSᵢ is yᵢ, the performance model construction unit 202 first estimates, for example, parameters σ, βᵢ, and γᵢ of the following model.

$${y}_{i} ∼ Norm ( exp ( {β}_{i} x + {γ}_{i} ) , σ )$$

Here, σ, βᵢ, and γᵢ are as follows.

σ˜HalfNorm(10⁴)

βᵢ˜Norm(μ_{β},σᵢ)

γᵢ˜Norm(μ_{γ},σᵢ′)

Here, the following Expression is established. σᵢ′ ˜HalfNorm(10⁴)

In this model, the throughput yᵢ of the base station BSᵢ follows a Gaussian distribution with a mean exp (βᵢx+γᵢ) and a standard deviation σ, βᵢ follows a Gaussian distribution with a mean μ_{β} and a standard deviation σᵢ, γᵢ follows a Gaussian distribution with a mean μ_{γ} and a standard deviation σᵢ′, and σᵢ′ follows a non-information prior distribution of a semi-normal distribution. Here, the trade-off between complete pooling and no pooling is adjusted for each base station by using the parameter σᵢ obtained in step S202 above for the prior distribution of βᵢ.

At this time, the performance model construction unit 202 learns the posterior distribution of the parameters σ, βᵢ, and γᵢ for the above model by the MCMC method to maximize the appearance probability of the observation information.

Then, the performance model construction unit 202 uses, for example, the average value μ_{β_i} of βᵢ after learning (where, “β_i” represents βᵢ) and the average value μ_{γ_i} of γᵢ after learning (where, “γ_i” represents γᵢ), the performance model of the base station BSᵢ is expressed as follows.

$$y = exp ( {μ}_{{β}_{i}} x + {μ}_{{γ}_{i}} ) \qquad [ Math . 3 ]$$

### SUMMARY

As described above, the performance model construction device 10 according to the present embodiment calculates the parameter σᵢ representing the magnitude of the variation from μ_{β}, which is one of the parameters representing the trend of the overall base stations, according to the number of observations of each base station, and then the performance model construction device 10 constructs the performance model in which the balance between the trend of the overall base stations and the trend of the base station BSᵢ alone is adjusted using the parameter σᵢ. As a result, for example, it is possible to construct a performance model in which a base station having a small number of observations focuses on the overall trend, while a base station having a large number of observations focuses on its own characteristics.

### <Modifications>

Hereinafter, modifications of the above embodiment will be described.

### Modification 1

In the above embodiment, the performance model common to all the base stations is constructed in step S202 in FIG. 5, but instead of this, the performance model common to the attributes may be constructed for each arbitrary attribute (for example, a frequency band) of each base station. In this case, the parameter σᵢ represents the magnitude of variation from μ_{β}, which is one of the parameters representing the trend of the performance model having the common attribute.

### Modification 2

In the above embodiment, the performance model for each base station is constructed in step S203 of FIG. 5, but instead of this, the performance model for each sector of the base station may be constructed, or the performance model for each carrier may be constructed.

### Modification 3

Modification 1 and Modification 2 above may be combined.

The present invention is not limited to the foregoing specifically disclosed embodiment, and various modifications, changes, combinations with known technique, and the like can be made without departing from the scope of the claims.

### REFERENCE SIGNS LIST

10 Performance model construction device
101 Input device
102 Display device
103 External I/F
103a Recording medium
104 Communication I/F
105 RAM
106 ROM
107 Auxiliary storage device
108 Processor
109 Bus
201 Input unit
202 Performance model construction unit
203 Output unit

1. A performance model construction apparatus configured to construct a performance model of each base station constituting a cellular network, the performance model construction apparatus comprising:
circuitry configured to
receive (i) a first value representing an observed number of accommodated users by each base station and (ii) a second value representing an observed performance related to the base station when the first value is observed, and
construct the performance model that represents a relationship between the number of accommodated users and the performance, based on the first value, the second value, and the number of observations for the first value and the second value.

2. The performance model construction apparatus according to claim 1, wherein the circuitry is configured to
calculate, for each of base stations, a parameter corresponding to the number of observations of the base station, and
construct, for each of the base stations, the performance model in which a first trend of all base stations and a second trend of the base station are adjusted using the parameter by hierarchical Bayesian modeling,
wherein the first trend and the second trend are in association with the relationship between the number of accommodated users and the performance.

3. The performance model construction apparatus according to claim 1, wherein the circuitry is configured to
calculate, for each of base stations, a parameter corresponding to the number of observations of the base station, and
construct, for each of the base stations, the performance model in which (i) a first trend of second base stations having a same attribute and (ii) a second trend of the base station are adjusted using the parameter by hierarchical Bayesian modeling,
wherein the first trend and the second trend are in association with the relationship between the number of accommodated users and the performance.

4. The performance model construction apparatus according to claim 3, wherein the second base stations represent a set of base stations using a same frequency band.

5. The performance model construction apparatus according to claim 1, wherein the circuitry is configured to
calculate, for each of base stations, a parameter corresponding to the number of observations of the base station, and
construct, for each of the base stations, the performance model in which (i) a first trend of second base stations in a same sector or with a same carrier and (ii) a second trend of the base station are adjusted using the parameter by hierarchical Bayesian modeling,
wherein the first trend and the second trend are in association with the relationship between the number of accommodated users and the performance.

6. The performance model construction apparatus according to claim 2, wherein the circuitry is configured to
calculate the parameter whose value increases in accordance with an increasing number of observations of the base station, and
calculate the parameter whose value decreases in accordance with a decreasing number of observations of the base station.

7. A performance model construction method executed by a performance model construction apparatus that constructs a performance model of each base station constituting a cellular network, the performance model construction method comprising:
receiving (i) a first value representing an observed number of accommodated users by each base station and (ii) a second value representing an observed performance related to the base station when the first value is observed; and
constructing the performance model that represents a relationship between the number of accommodated users and the performance, based on the first value, the second value, and the number of observations for the first value and the second value.

8. A non-transitory computer readable storage medium storing a program for causing a computer to execute the performance model construction method of claim 7.
